(19) United States
(12) Patent Application Publication
(10) Pub. No.: US 2022/0019737 A1
(43) Pub. Date: Jan. 20, 2022

(54) LANGUAGE CORRECTION SYSTEM, METHOD THEREFOR, AND LANGUAGE CORRECTION MODEL LEARNING METHOD OF SYSTEM

(71) Applicant: LLSOLLU CO., LTD., Seoul (KR)

(72) Inventors: Jong Keun CHOI, Hwaseong-si (KR); Sumi LEE, Seoul (KR); Dongpil KIM, Seoul (KR)

(73) Assignee: LLSOLLU CO., LTD., Seoul (KR)

(21) Appl. No.: 17/311,870

(22) PCT Filed: Dec. 24, 2019
(86) PCT No.: PCT/KR2019/018384

§ 371 Date: Jun. 8, 2021

(30) Foreign Application Priority Data
Dec. 31, 2018 (KR) 10-2018-0174248
Mar. 18, 2019 (KR) 10-2019-0030688

(51) Int. Cl. G06F 40/253; G06F 40/58; G06N 20/00

(52) U.S. Cl. CPC G06F 40/253; G06N 20/00; G06F 40/58

(57) ABSTRACT

A language correction system, a method therefor, and a language correction model learning method of the system are disclosed. The system comprises a correction model learning unit and a language correction unit. The correction model learning unit performs machine learning on a plurality of data sets consisting of ungrammatical sentence data and error-free grammatical sentence data respectively corresponding to the ungrammatical sentence data, so as to generate a correction mode for detecting grammatical sentence data corresponding to ungrammatical sentence data to be corrected. The language correction unit generates, for a sentence to be corrected, a corresponding corrected sentence by using the correction model generated by the correction model learning unit, and displays and outputs the corrected parts together with the generated corrected sentence.

### TECHNICAL FIELD

The present invention relates to a language correction system, a method therefor, and a language correction model learning method of the system.

### BACKGROUND ART

Language correction refers to correcting spelling errors or grammatical errors in sentences written in various types of languages, for example, language sentences written on the Internet or distributed through the Internet, that is, Internet data. The language correction may include not only correction for misspelled or ungrammatical expressions, but also correction for making sentences simpler and easier to read.

The above-described language correction may be used for language learning, or a task for maintaining a certain level of text publications such as books or newspaper articles, and may be used in various forms in an area requiring the language correction.

In particular, recently, a large amount of language data is distributed or used through the Internet. The conventional language correction performs a simple form of spelling or grammar-oriented language correction by using a statistical model. However, more efficient language correction has been required for a large amount of language data in recent years.

### DISCLOSURE

### Technical Problem

The present invention provide a language correction system, a method therefor, and a language correction model learning method of the system so as to provide efficient language correction results by using a machine learning-based correction model.

### Technical Solution

A language correction system according to one aspect of the present invention is a machine learning-based language correction system which includes: a correction model learning unit that performs machine learning on a plurality of data sets consisting of ungrammatical sentence data and error-free grammatical sentence data respectively corresponding to the ungrammatical sentence data to generate a correction mode for detecting grammatical sentence data corresponding to ungrammatical sentence data to be corrected; and a language correction unit that generates, for a sentence to be corrected, a corresponding corrected sentence by using the correction model generated by the correction model learning unit, and displays and outputs the corrected portions together with the generated corrected sentence.

The correction model learning unit includes: a pre-processing part that performs a filtering task into a monolingual sentence and a data purification and normalization task by performing language detection on the ungrammatical sentence data; a learning processing part that performs a supervised learning data labeling task, a machine learning data augmentation task, and a parallel data construction task for machine learning, with respect to a plurality of data sets filtered by the pre-processing part; a correction learning part that generates the corresponding correction model by performing supervised learning-based machine learning on the data sets processed by the learning processing part; and a first post-processing part that outputs error and error category information through tag additional information added during the supervised learning data labeling task in the learning processing part and then removes the corresponding tag additional information.

In addition, the machine learning data augmentation task in the learning processing part includes a data augmentation task using letters formed fro m surrounding typing error characters around an in-position of a keyboard for typing letters included in the ungrammatical sentence data.

In addition, the parallel data construction task for machine learning in the learning processing part includes a task of constructing parallel data using a parallel corpus formed by paring ungrammatical sentences unnecessary for correction and corresponding grammatical sentences.

In addition, the correction learning part provides an error occurrence probability value, for a learning result in the supervised learning-based machine learning, as attention weight information between the ungrammatical sentence data and the grammatical sentence data.

In addition, the system further includes a translation engine for translating input sentences into a preset language, wherein the pre-processing part marks words, which are unregistered in a dictionary used by the translation engine, by using a preset marker while performing a translation on a large amount of ungrammatical sentence data in the data sets through the translation engine completes the translation on the large amount of ungrammatical sentence data, and performs preliminary correction of extracting the words marked by the preset marker to collectively correct the words into error-free words.

In addition, the pre-processing part checks a frequency while extracting the words marked by the preset marker, and aligns the words marked by the preset marker based on the checked frequency to collectively correct the words into error-free words.

In addition, the language correction unit includes: a pre-processing part that performs pre-process of performing a sentence segmentation, for sentences to be corrected, in a unit of sentence, and tokenizing the segmented sentences; an error sentence detection part for classifying the sentences to be corrected that has been pre-processed by the pre-processing part into error sentences and non-error sentences by using a binary classifier; a spelling correction part for correcting a spelling error on the sentence to be corrected, classified as the error sentence by the error sentence detection part; a grammar correction part for generating a corrected sentence by performing language correction for grammar correction using the correction model on the sentence in which the spelling error is corrected by the spelling correction part; and a post-processing part that performs post-processing of indicating a corrected portion during the language correction by the grammar correction part and outputs the corrected part together with the corrected sentence.

In addition, the error sentence detection part classifies the error sentence and the non-error sentence according to reliability information recognized when the sentence to be corrected is classified.

In addition, the spelling correction part provides a spelling error occurrence probability value as reliability information when correcting a spelling error, the grammar correction part provides a probability value through an attention weight of language correction for the spelling error-corrected sentence as reliability information, and the post-processing part proves final reliability information of language correction for the sentence to be corrected, by combining the reliability information provided by the spelling correction part and the reliability information provided by the grammar correction part.

In addition, the system further includes a language modeling unit disposed between the grammar correction part and the post-processing part to per form language modeling using a preset recommended sentence for the corrected sentence generated by the grammar correction part, wherein the language modeling unit provides reliability information of the corrected sentence by combining a perplexity value and a mutual information (MI) value of a language model during the language modeling, and the post-processing part also combines the reliability information provided by the language modeling unit when providing the final reliability information.

In addition, the system further includes a user dictionary including a source word registered by a user and a target word corresponding thereto, wherein each of the source word and the target word is at least one word, the correction model learning unit, when the word registered in the user dictionary is included in the data sets, replaces the corresponding word with a preset user dictionary marker to perform machine learning, the language correction unit replaces the word included in the user dictionary, when the word included in the user dictionary is present in the sentence to be corrected, with the user dictionary marker to perform language correction on the sentence to be corrected, and replaces the user dictionary marker, when the user dictionary marker is included in the corrected sentence, with the word registered in the user dictionary to correspond to a corresponding word in the sentence to be corrected.

The language correction model learning method according to another aspect of the present invention is a method for enabling a language correction system to learn a language correction model based on machine learning. The method includes: performing a learning processing including a supervised learning data labeling task, a machine learning data augmentation task, and a parallel data construction task for machine learning, on a plurality of data sets consisting of ungrammatical sentence data and error-free grammatical sentence data corresponding to the ungrammatical sentence data, respectively; and generating a corresponding correction model by performing supervised learning-based machine learning on the data sets on which the learning processing has been performed.

The machine learning data augmentation task includes a data augmentation task using letters formed from surrounding typing error characters around an in-position of a keyboard for typing letters included in the ungrammatical sentence data, and the parallel data construction task for machine learning includes a task of constructing parallel data using a parallel corpus formed by paring ungrammatical sentences unnecessary for correction and corresponding grammatical sentences.

In addition, the method further includes: before performing the learning processing, performing pre-processing including a filtering task into a monolingual sentence and a data purification and normalization task, by performing language detection on the data sets, wherein the performing of the pre-processing includes: performing a translation on a large amount of ungrammatical sentence data in the data sets through the translation engine; marking words, which are unregistered in a dictionary used by the translation engine, by using a preset marker; extracting the words marked by the preset marker after completing the translation on the large amount of ungrammatical sentence data; and collectively correcting the extracted words into error-free words.

In addition, the collectively correcting of the words includes: extracting the words marked by the preset marker; checking a frequency of the extracted words; arranging the words marked by the preset marker based on the checked frequency; and collectively correcting the arranged words into error-free words.

In addition, the language correction system further includes a user dictionary including a source word registered by a user and a target word corresponding thereto in which each of the source word and the target word is at least one word, and when the word registered in the user dictionary is included in the data sets, the generating of the correction model includes replacing the corresponding word with a preset user dictionary marker to perform machine learning, thereby generating the correction model.

The language correction method according to still another aspect of the present invention is a method for enabling a language correction system to perform a language correction based on machine learning. The method includes: performing spelling error correction on sentences to be corrected; and generating a corrected sentence by performing grammar correction by using a correction model on the spelling error-corrected sentence, wherein the correction model is generated by performing supervised learning-based machine learning on a plurality of data sets consisting of ungrammatical sentence data a nd error-free grammatical sentence data corresponding to the ungrammatical sentence data, respectively.

The method further includes: before the performing the spelling error correction, performing pre-process of performing a sentence segmentation, for the sentences to be corrected, in a unit of sentence, and tokenizing the segmented sentences; and classifying the sentences to be corrected that has be en pre-processed into error sentences and non-error sentences by using a bi nary classifier, wherein, in the classifying of the error sentences and the non-error sentences, the spelling error correction is performed when the sentence to be corrected is classified as the error sentence.

In addition, in the classifying of the error sentences and the non-error sentences, the error sentence and the non-error sentence are classified according to reliability information recognized when the sentence to be corrected is classified.

In addition, the method further includes: after the generating of the corrected sentence, performing language modeling on the corrected sentence by using a preset recommendation sentence; and performing post-processing of indicating a corrected part during the generating of the corrected sentence to output the corrected portion together with the corrected sentence.

In addition, the language correction system further includes a user dictionary including a source word registered by a user and a target word corresponding thereto in which each of the source word and the target word is at least one word, and the method includes: before the performing the spelling error correction, determining whether the word included in the user dictionary is included in the sentence to be corrected; and replacing a word commonly included in the user dictionary and the sentence to be corrected with a preset user dictionary marker, when the word included in the user dictionary is included in the sentence to be corrected, and the method further includes: after the generating of the corrected sentence, checking whether the user dictionary marker is included in the generated corrected sentence; and generating a final corrected sentence by replacing the word in the user dictionary corresponding to the word in the sentence to be corrected corresponding to a position of the included user dictionary marker, when the user dictionary marker is included in the generated corrected sentence.

### Advantageous Effects

According to the embodiments of the present invention, the machine learning-based correction model is used, so that efficient language correction results can be provided.

In addition, the machine learning-based correction model may be used for language education correction instruction, so that online learning system can be developed.

In addition, typing errors/grammar errors may be removed in sentence-unit search, so that search performance can be improved.

In addition, various office tools may be applied so that document creation can be facilitated.

In addition, correction information in the form predefined by the user may be stored in the form of a variable and processed in the runtime, so that the language correction can be easily performed without a separate addition or change to the correction model.

In addition, even portions that are difficult to correct or cannot be treated smoothly may be registered in the user dictionary and processed, so that the efficiency of language correction can be improved.

### DESCRIPTION OF DRAWINGS

FIG. 1 is a schematic configuration diagram of a language correction system according to the embodiments of the present invention.

FIG. 2 is a detailed configuration diagram of a correction model learning unit shown in FIG. 1.

FIG. 3 is a detailed configuration diagram of a language correction unit shown in FIG. 1.

FIG. 4 is a diagram showing an example of a result of performing language correction by the language correction system according to the embodiments of the present invention.

FIG. 5 is a schematic flowchart of a machine learning-based language correction method according to the embodiments of the present invention.

FIG. 6 is a schematic flowchart of a learning a language correction model method according to the embodiments of the present invention.

FIG. 7 is a detailed configuration diagram of a correction model learning unit according to another embodiment of the present invention.

FIG. 8 is a flowchart of a pre-correction method of a correction model learning sentence according to another embodiment of the present invention.

FIG. 9 is a diagram showing an example of the pre-correction method of the correction model learning sentence according to another embodiment of the present invention.

FIG. 10 is a schematic configuration diagram of a language correction system according to another embodiment of the present invention.

FIG. 11 is a detailed configuration diagram of the correction model learning unit shown in FIG. 10.

FIG. 12 is a detailed configuration diagram of the language correction unit shown in FIG. 10.

FIG. 13 is a flowchart of the language correction model learning method according to another embodiment of the present invention.

FIG. 14 is a flowchart of the language correction method according to another embodiment of the present invention.

### BEST MODE

### Mode for Invention

Hereinafter, embodiments of the present invention will be described in detail with reference to the accompanying drawings, so that a person having ordinary skill in the art may easily carry out the present invention. However, the invention may be embodied in various different forms and is not limited to the embodiments described herein. In addition, parts irrelevant to the description are omitted in the drawings to clearly describe the present invention, and similar reference numerals are used for similar parts throughout the specification.

Throughout the specification, when a part “includes” a certain component, the above expression does not exclude other components, but may further include the other components, unless particularly stated otherwise

In addition, the term “unit”, “device”, “module”, or an equivalent thereof signifies a unit for processing at least one function or operation, and may be implemented in hardware or software or a combination of hardware and software.

Hereinafter, a language correction system according to the embodiments of the present invention will be described with reference to the drawings.

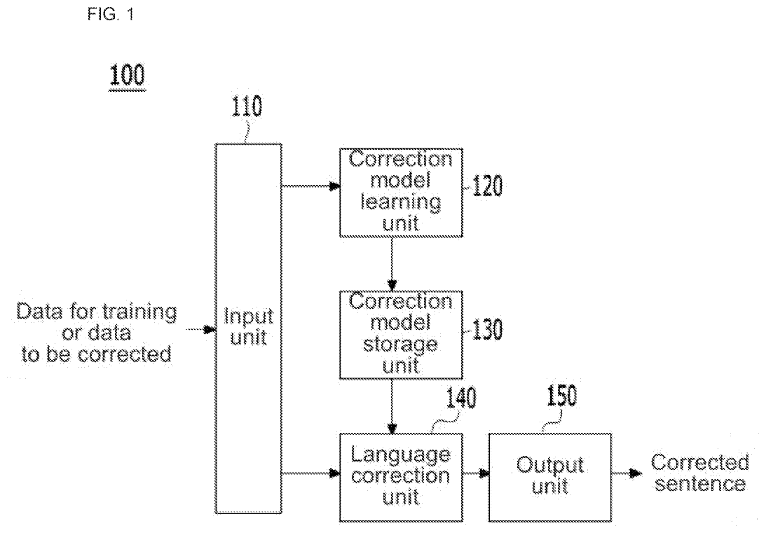

FIG. 1 is a schematic configuration diagram of a language correction system according to the embodiments of the present invention.

As shown in FIG. 1, the language correction system 100 according to the embodiments of the present invention includes an input unit 110, a correction model learning unit 120, a correction model storage unit 130, a language correction unit 140, and an output unit 150. The language correction system 100 shown in FIG. 1 is merely one embodiment of the present invention, so the present invention is not construed to be limited through FIG. 1, and may be configured differently from FIG. 1 according to various embodiments of the present invention.

The input unit 110 receives data used for learning of language correction, or data to be corrected as an object of the language correction. For the data used for learning of language correction, ungrammatical sentence data containing correction information and error-free grammatical sentence data are inputted in pairs as a large amount of Internet data for supervised learning-based machine learning to be described later.

The correction model learning unit 120 performs machine learning for language correction by using data used for learning of language correction among the data inputted through the input unit 110, that is, a large amount of learning data consisting of a pair of ungrammatical sentence data and grammatical sentence data, so that a correction model serving as a learning model for language correction is generated. The correction model generated by the correction model learning unit 120 is stored in the correction model storage unit 130. Meanwhile, the above-described machine learning is a field of artificial intelligence, and refers to a technology that predicts the future by analyzing vast amounts of data, and a technology that solves problems by acquiring information that has not been inputted while the computer goes through learning processes by itself. Deep learning techniques using neural networks such as convolutional neural network (CNN), recurrent neural network (RNN), and Transformer Networks may be used for the machine learning. These machine learning techniques are already well known, so detailed descriptions will be omitted herein.

The correction model storage unit 130 stores the correction model generated through machine learning by the correction model learning unit 120.

The language correction unit 140 performs spelling/grammar correction on the data to be corrected using the correction model stored in the correction model storage unit 130 with respect to the large amount of language correction data inputted through the input unit 110, that is, the data to be corrected as a correction object for spelling errors or grammar errors, and outputs correction data having completed in correction to the output unit 150.

Selectively, the language correction unit 140 may additionally perform a language modeling task for correcting a sentence into a natural sentence, even when the correction is unnecessary because the spelling/grammar correction for the data to be corrected is completed.

The output unit 150 receives the data to be corrected together with the correction data having completed in the language correction from the language correction unit 140 and outputs the received data to the outside, for example, to the user.

In addition, the output unit 150 may output the data to be corrected together with the corresponding correction data. Selectively, the output unit 150 may additionally indicate the correction data such that a portion where the correction has been performed can be recognized in the data to be corrected. Information on the portion where the correction has been performed is provided from the language correction unit 140 to the output unit 150.

Meanwhile, the correction model learning unit 120 and the language correction unit 140 may be implemented as a single component after integrated with each other, or may be implemented as separate devices from each other. For example, they may be implemented as separate devices like a correction model learning device only including the input unit 110, the correction model learning unit 120, and the correction model storage unit 130, and a language correction device only including the input unit 110, the correction model storage unit 130, the language correction unit 140, and the output unit 150.

Hereinafter, the above-described correction model learning unit 120 will be described in more detail.

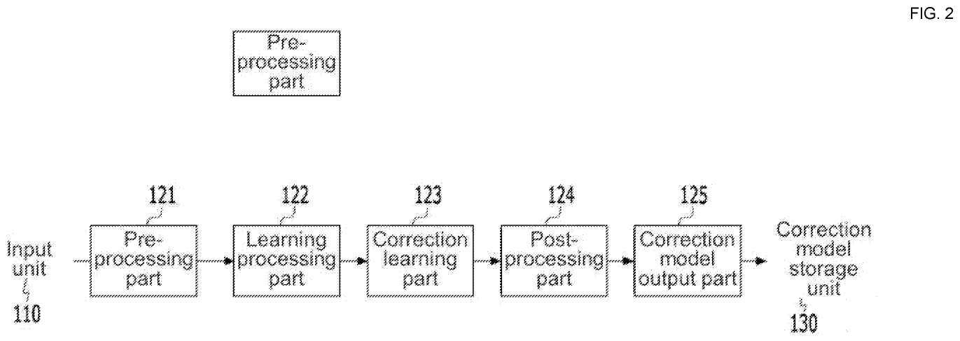

FIG. 2 is a detailed configuration diagram of the correction model learning unit 120 shown in FIG. 1.

As shown in FIG. 2, the correction model learning unit 120 includes a pre-processing part 121, a learning processing part 122, a correction learning part 123, a post-processing part 124, and a correction model output part 125.

Before the description, the machine learning of the correction model performed in the embodiment of the present invention uses supervised learning, however, the present invention is not limited thereto. Herein, the supervised learning refers to learning a mapping between input and output, and is applied when input and output pairs are given as data. When the embodiment of the present invention is applied, the ungrammatical sentence data, which is source data for spelling correction and grammar correction, corresponds to the input, and correspondingly, the grammatical sentence data as target data corresponding to the corrected sentence corresponds to the output. Since the machine learning method according to the supervised learning is already well known, detailed descriptions will be omitted herein.

the pre-processing part 121 filters the data used for learning of language correction among the data inputted through the input unit 110, that is, a large amount of learning data consisting of a pair of ungrammatical sentence data (also referred to as “source sentence”) and grammatical sentence data (also referred to as “target sentence”) into a monolingual sentence by applying language identification technology to the ungrammatical sentence data and the grammatical sentence data. In other words, the ungrammatical sentence data or the grammatical sentence data is filtered into monolingual sentences through language detection so that learning can be performed based on the basically same language.

Selectively, the pre-processing part 121 may additionally filter a code switching part during the language detection. For example, in the case of the expression in which English and Korean are mixed, such as “Korea [symbol] traditional [symbol] thinking [symbol] ”, the expression is filtered through language detection technology for code switching even when different languages are used, so that the expression in the different languages remains within the sentence without being removed.

In addition, the pre-processing part 121 performs purification on the ungrammatical sentence data. The purification may be applied to monolingual corpus or parallel corpus.

Besides, the pre-processing part 121 may further perform tasks, such as check for duplicate or empty information in source/target sentences, set maximum/minimum number of characters/words, limit on the number of spaces in characters and words, limit on uppercase or number, limit on repeated words, check for non-graphic/non-printable character, and Unicode processing error, check for foreign language rate, check for encoding validity, and the like. Since the above tasks are generally known, detailed descriptions will be omitted herein.

In addition, the pre-processing part 121 may additionally perform data normalization according to different Unicode, punctuation marks, upper and lower case letters, and regional spellings. The data normalization may also be integrated with the above-described data purification.

The learning processing part 122 is configured to prepare data necessary for machine learning performed by the correction learning unit 123 later by using a pair of data pre-processed by the pre-processing unit 121, that is, a pair of the ungrammatical sentence data and the grammatical sentence data, and configured to perform a supervised learning data labeling task, a machine learning data augmentation task, and a parallel data construction task for machine learning. The supervised learning data labeling task, the machine learning data augmentation task, and the parallel data construction task for machine learning may not be executed sequentially. In addition, only some task, not all tasks, may be executed.

First, the supervised learning data labeling task is executed as follows. Information on a correction type (insertion, replacement, and deletion) in the correction sentence is added as additional information by using an edit distance of words and characters.

In addition, error category information is added. The error category information includes spelling errors (such as omission, addition, false choice, and misplacement), grammatical errors (errors in parts of speech, consistency, and the like), language model errors (errors in sentence construction, substitute reference, idiomatic expression, semantic representation, mode expression, etc.).

The error category information may be referred to the following [Table 1].

TABLE 1

| Classification of | | Subclassification | | |
|---|---|---|---|---|
| errors | | of errors | Tag | Description |
| Spelling error | | Omission | SO | Punctuation marks, |
| (character level) | | | | spelling, etc. are missing |
| | | | | Ex: Discu(s)sion, h(e)ight, |
| | | | | definit(e) |
| | | Addition | SA | Unnecessary punctuation |
| | | | | marks, spellings, etc. are |
| | | | | added |
| | | | | Ex: den(n)otation, |
| | | | | forei(l)gn, ju(i)dgement |
| | | False Choice | SF | Incorrect letters, such as |
| | | | | case errors, are used |
| | | | | Ex: absen(s)e, abs(a)nce, |
| | | | | indisp(a)nsable |
| | | Misplacement | SM | Incorrect letter order is |
| | | | | included |
| | | | | Ex: ac(nk)owledge, |
| | | | | acq(au)instance, l(ie)sure |
| Grammatical | Part of | Preposition | Gpre | Prepositions incorrectly |
| error | speech | | | used as a concept such |
| (word/phrase/ | | | | as place, cause, purpose, |
| clause level) | | | | method, source, time, etc. |
| | | Conjunction | GCon | Errors in coordinate, |
| | | | | subordinate and correlation |
| | | | | conjunctions, conjunctive |
| | | | | adverbs, etc. |
| | | Noun | GN | Errors in using nouns such |
| | | | | as countless/countable |
| | | | | nouns |
| | | Article | GA | Inappropriate combination |
| | | | | of definite/indefinite articles |
| | | | | with a noun |
| | | Pronoun | GPro | Errors in indefinite |
| | | | | pronouns, personal |
| | | | | pronouns, reflexive |
| | | | | pronouns, etc. |
| | | Adverb | GAdv | Usage errors in position of |
| | | | | adverbs, comparisons, etc. |
| | | Adjective | GAdj | Usage errors in position of |
| | | | | adjectives, comparisons, |
| | | | | etc. |
| | | Verb | GV | Verb usage errors in as |
| | | | | tense of verb and auxiliary |
| | | | | verbs |
| | Consistency | Case | GCas | Usage errors in |
| | | | | possessive, objective |
| | | | | nouns, etc. |
| | | Gender | GG | Inappropriate use of |
| | | | | feminine, masculine nouns, |
| | | | | etc. |
| | | Number | GN | Errors in plural/singular |
| | | | | nouns used with |
| | | | | singular/plural verbs |
| | | Personal | GPer | Improper consistency of |
| | | | | masculine/feminine nouns |
| | Others | Relative | GR | Errors in use of relative |
| | | | | pronouns, etc. |
| | | Number | GN | Date/time notation, |
| | | | | currency, quantity, ordinal |
| | | | | number, cardinal number, |
| | | | | etc. |

| | | | |
|---|---|---|---|
| Language model | Sentence form | LSfo | Grammatical errors in |
| (sentence/paragraph | | | sentence structure such as |
| level) | | | grammar word order |
| | | | errors, passive/active |
| | | | voices, main/subordinate |
| | | | sentences |
| | Anaphoric | LA | Inappropriate use such as |
| | Reference | | anaphoric between |
| | | | sentences |
| | Idiom | LI | Sentences misrepresented |
| | | | by Idiom, etc. |
| | Semantic | LSem | Inappropriate meaning is |
| | | | expressed such as actors, |
| | | | experienced persons, |
| | | | target class, and tool class |
| | | | through thematic role |
| | | | recognition |
| | Mode | LM | Expressions inappropriate |
| | | | for pragmatic modes such |
| | | | as honorific/honor, |
| | | | spoken/written, etc. |

In addition, ungrammatical sentence and grammatical sentence classification information is added in a binary form. Through the ungrammatical sentence and grammatical sentence classification information, the case, in which training data, that is, both of the pair of the ungrammatical sentence data and the grammatical sentence data, are classified as a grammatical sentence unnecessary for correction, may be identified. Since this may be classified as ungrammatical sentence data that is unnecessary for correction, data can be expanded through the use of the training data later. In addition, afterward, the fact that a correction is unnecessary may be quickly checked and replied. A probability value, in which the ungrammatical sentence data corresponds to the ungrammatical sentence or the grammatical sentence, can be indicated while the classification between the grammatical sentence unnecessary for correction and the ungrammatical sentence unnecessary for correction is performed through a binary classifier with respect to the ungrammatical sentence data.

In addition, the information on the code switching part performed by the pre-processing part 121 is labeled. For example, a Korean-English code switching part is labeled.

In addition, tag information is added after various natural language processing is performed. The various natural language processing may include sentence separation, token separation, morpheme analysis, syntax analysis, entity name recognition, thematic role recognition, cross-reference, paraphrase, etc.

In addition, language feature information may be used to add necessary detailed error category information in [Table 1] to enable machine learning.

Next, the machine learning data augmentation task is as follows. The machine learning data augmentation task refers to a task for increasing the amount of machine learning data to be used when learning in the correction learning part 123 later.

The machine learning data augmentation may be performed by adding various types of noise to the ungrammatical sentence data. The noise may include words/spelling omissions, substitutions, additions, spacing errors, and foreign language additions.

In addition, the data augmentation may be performed by focusing on typing errors having high frequency.

In addition, the data augmentation may be performed by focusing on typing errors of letters around a keyboard. In other words, the data augmentation may be performed by using typing errors of characters formed around an in-position of the keyboard for typing a specific character of the ungrammatical sentence data. Due to the data augmentation by focusing on the typing errors around the characters of the keyboard, language correction in sentences entered through a smartphone using a small keyboard may be performed very efficiently.

In addition, the data augmentation may be performed by applying algorithms used in unsupervised learning such as variational autoencoder (VAE) and generative adversarial networks (GAN).

Next, the parallel data constructing task for machine learning is as follows.

With respect to the augmented data, that is, the large amount of data pairs as mentioned above, a parallel data construction task is performed to construct a parallel corpus that pairs ungrammatical sentences which are correction sentences containing noise and grammatical sentences unnecessary for correction.

In addition, the ungrammatical sentence and grammatical sentence classification information is added in the binary form in the pre-processing unit 121, so that a parallel data construction task is performed to construct a parallel corpus with pairs of sentences unnecessary for correction by using the ungrammatical sentence data unnecessary for correction. Accordingly, when the data to be corrected is not necessary for correction in a language correction unit 140 later due to the parallel data construction using the parallel corpus with pairs of the sentences unnecessary for correction, the data to be corrected may be processed to prevent a task for correction from being performed, so that the overall correction tasks may be quickly processed. A language modeling for making sentences natural may also be performed even on the data to be corrected that is unnecessary for the correction.

The correction learning part 123 applies supervised learning-based machine learning as described above by combining the data pair processed by the learning processing part 122, that is, the parallel data constructed on the basis of the ungrammatical sentence data and the grammatical sentence data, so as to generate the corresponding correction model. The present invention is not limited to the supervised learning, and the correction learning may also be performed through unsupervised learning-based machine learning. In this case, a process may be required to allow the previous pre-processing or data processing to be applied to the unsupervised learning-based machine learning. The correction learning part 123 may provide an error occurrence probability value for a machine learning result in the supervised learning-based machine learning. The error occurrence probability value may be attention weight information between the ungrammatical sentence and the grammatical sentence.

Selectively, the correction learning part 123 may utilize embedding vectors previously learned based on large-capacity Internet data. In other words, the data pre-learned extensively from the outside may be utilized.

The post-processing part 124 outputs errors and error category information through tag additional information added during the supervised learning data labeling task in the learning processing part 122, and then removes the corresponding tag additional information.

The correction model output part 125 outputs and stores the correction model generated by the correction learning part 123 to the correction model storage unit 130.

Next, the above-described language correction unit 140 will be described in more detail.

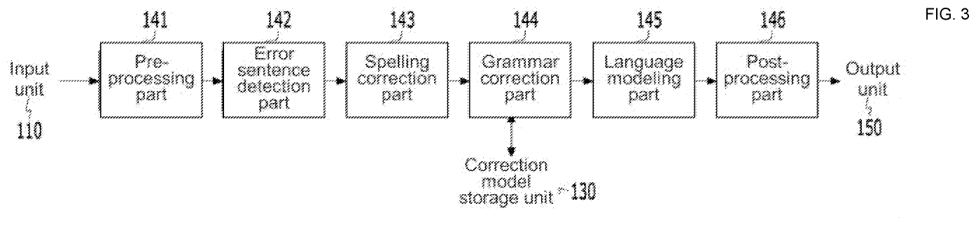

FIG. 3 is a detailed configuration diagram of the language correction unit 140 shown in FIG. 1.

As shown in FIG. 3, the language correction unit 140 includes a pre-processing part 141, an error sentence detection part 142, a spelling correction part 143, a grammar correction part 144, a language modeling part 145, and post-processing part 146.

The pre-processing part 141 performs a sentence segmentation task on the data to be corrected for language correction inputted through the input unit 110. This sentence segmentation task refers to a task of dividing the input unit into a sentence unit after recognizing an end unit of each sentence included in the data to be corrected.

In addition, the pre-processing part 141 variously tokenizes the divided sentences. The tokenization refers to cutting a sentence into a desired unit. For example, the tokenization may be performed in units of letters, words, subwords, morphemes, word phases and the like.

In addition, the pre-processing part 141 may perform a data normalization task as performed by the pre-processing part 121 of the correction model learning unit 120.

Next, the error sentence detection part 142 uses a binary classifier to distinguish error sentences and non-error sentences through information already tagged in the pre-processing part 141. This is a scheme of classifying input sentences and machine-learned error sentences or non-error sentences by measuring the similarity, based on data expanded by adding a non-error sentence at a position of an error sentence in addition to the training data of the existing error/non-error sentence pairs. When distinguishing between the error sentences and the non-error sentences, corresponding reliability values are indicated.

The error sentence detection part 142 detects as an error sentence when the reliability value is greater than or equal to a threshold value, and detects as a non-error sentence when the reliability value is less than the threshold value.

According to the error sentence detection result in the error sentence detection part 142, the data to be corrected is transferred to the spelling correction part 143 when the sentence is detected as the error sentence, but directly transferred to the language modeling part 145 without passing through the spelling correction part 143 and the grammar correction part 144 when detected as the non-error sentence.

The spelling correction part 143 detects and corrects misspellings in a sentence to be corrected in the data to be corrected that is transferred from the error sentence detection part 142. The spelling correction herein may include correction for punctuation errors such as spaces, punctuation marks (period, question mark, exclamation mark, comma, middle point, colon, slash marks, double quotation mark, single quotation mark, parentheses, curly braces, square brackets, double scare quotes and double arrow brackets, single scare quotes and single arrow brackets, dashes, hyphen marks, punctuation marks, tildes, revealing marks and underscores, hidden marks, omission marks, and ellipsis) etc. In addition, a corresponding correction model may be generated by performing machine learning for spelling correction with respect to the above spelling correction, and the spelling correction may be performed using the correction model generated in the above way. However, as mentioned above, the spelling correction is not an object to which machine learning is necessarily applied, so the spelling correction may be performed using an existing spelling-based standard word dictionary or the like.

Selectively, the spelling correction part 143 may provide a dictionary-based spelling error probability value as reliability information with respect to the spelling correction for the data to be corrected.

The grammar correction part 144 performs language correction, particularly, grammar correction on the data to be corrected that has been corrected with spelling from the spelling correction unit 143, by using the correction model stored in the correction model storage unit 130. In other words, the grammar correction part 144 may obtain corrected data for the data to be corrected as a result by applying the correction model to the data to be corrected. A probability value through attention weights, that is, reliability information may be provided together with data corrected by the correction model.

The language modeling part 145 performs language modeling that corrects sentences into more natural sentences in the grammatical and semantic/pragmatic ranges even when correction is unnecessary for the data corrected by the grammar correction part 144 or the non-error sentence transferred from the error sentence detection part 142. The above language modeling may also use a scheme using machine learning as in the correction model, but is not applied in the present invention, and it will be described only as performing the language modeling on corresponding sentences using various types of recommended sentences.

Selectively, the language modeling part 145 may provide reliability information of correction sentences by combining values of the perplexity (PPL) and mutual information (MI) of the language model while performing the language modeling.

The post-processing part 146 indicates a corrected portion of the corrected data in which the language modeling has been performed by the language modeling part 145. The indication of the corrected portions may be performed through visualization of error information by using various colors.

Selectively, the post-processing part 146 may provide final reliability information of the language correction for the data to be corrected by combining the weighted sum of reliability calculated from each component based on heuristics, such as a reliability value serving as a probability value and provided when the error sentence detection part 142 uses the binary classifier to classify the data into the error sentence and the non-error sentence, reliability information serving as a dictionary-based spelling error occurrence probability value and provided when the spelling correction unit 143 corrects the spellings, attention weight information provided when the grammar correction part 144 performs the language correction, the publicity value of the language model provided by the language modeling part 145, the mutual information (MI), etc.

Selectively, the post-processing part 146 may perform N-best sentence processing on one data to be corrected. In other words, the reliability of each candidate is provided as a ranking while providing a plurality of corrected data candidates for one data to be corrected, so that the corrected data may be selected by the user. The above processing may be performed in cooperation with the output unit 150.

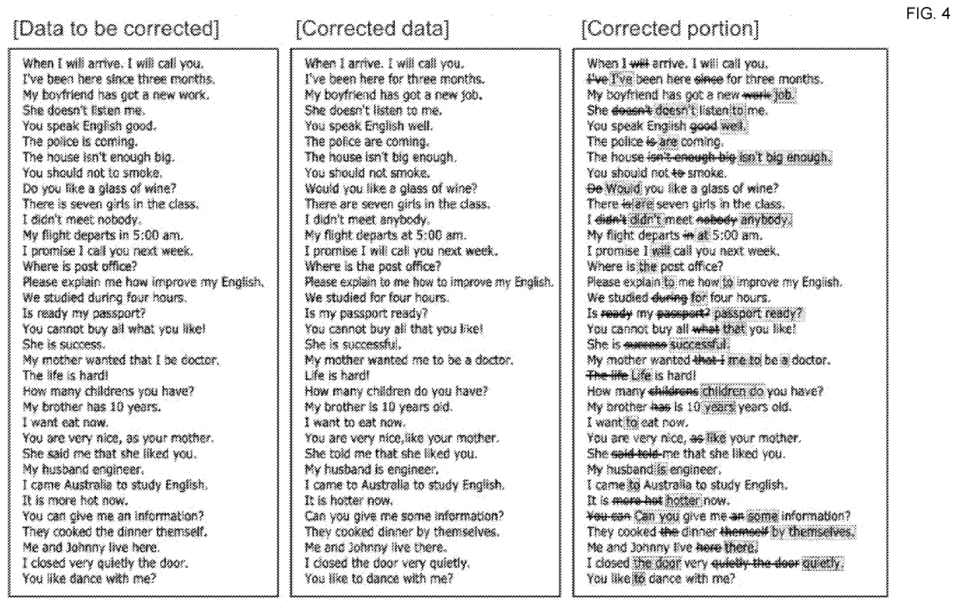

Next, the output unit 150 receives the data to be corrected together with the correction data having completed in the language correction from the language correction unit 140 and outputs the received data to the outside. The output unit 150 may output the data to be corrected together with the corresponding correction data and corrected portions. For example, as shown in FIG. 4, the data to be corrected (Source), the corrected data (Suggestion), and the corrected portions are indicated together on the left, in the middle and on the right, respectively, so that the corrected data and the corrected portions may be clearly recognized for the data to be corrected.

Hereinafter, a machine learning-based language correction method according to the embodiments of the present invention will be described.

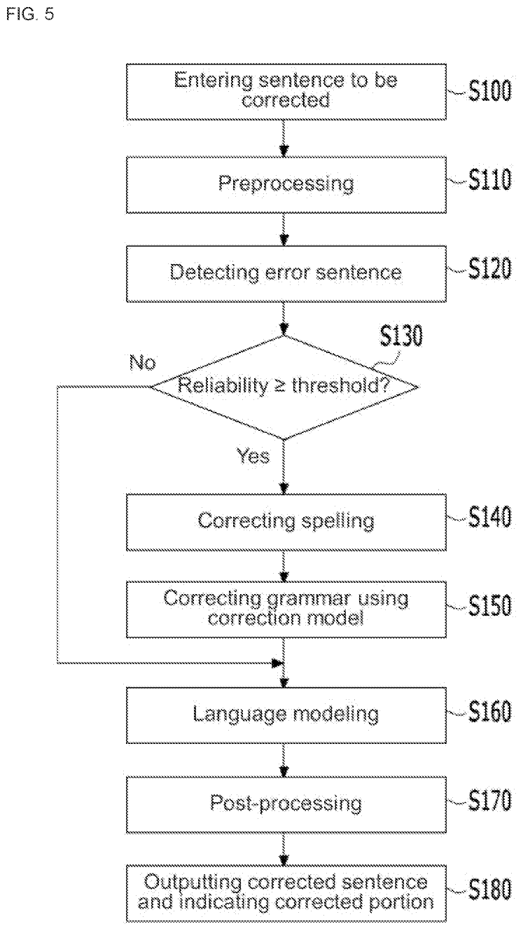

FIG. 5 is a schematic flowchart of a machine learning-based language correction method according to the embodiments of the present invention.

The machine learning-based language correction method shown in FIG. 5 may be performed by the language correction system 100 described with reference to FIGS. 1 to 4.

Referring to FIG. 5, first, when a sentence to be corrected for language correction is inputted (S100), a pre-processing task including a sentence separation task, a tokenization task, a normalization task, and the like is performed on the inputted sentence to be corrected (S110). Refer to FIG. 3 for the pre-processing task including the sentence separation task, the tokenization task, the normalization task, and the like.

Next, an error sentence is detected by using a binary classifier for the sentence to be corrected on which the pre-processing has been performed (S120). At this point, reliability for error sentence detection may be provided together as described with reference to FIG. 3.

Accordingly, it can be seen that an error has been detected when the reliability provided in the step (S120) is greater than or equal to a preset threshold, language correction is necessary, and otherwise, the language correction is unnecessary as a non-error sentence in which no error is detected.

Accordingly, when it is determined whether the reliability is equal to or greater than the preset threshold (S130), and when the reliability is equal to or greater than the preset threshold, first, spelling correction, that is, orthography correction is performed on the sentence to be corrected (S140). See details described with reference to FIG. 3 for the spelling correction.

Then, language correction, specifically, grammar correction is performed by using a generation model previously generated through supervised learning-based machine learning with respect to the sentences to be corrected that has been spelling-corrected, so that corrected sentence corresponding to the sentence to be corrected is output (S150). The generation model provides information on corrected portion from the sentence to be corrected to the corrected sentence. In addition, an attention weight may be provided together as reliability information for correction of the sentence to be corrected.

Next, a language modeling, which corrects sentences into more natural sentences in the grammatical and semantic/pragmatic ranges, is performed on the corrected sentences (S160). See the description with reference to FIG. 3 for the language modeling as well.

Accordingly, for the language-modeled sentences, a post-processing task, such as providing reliability information for the above-described language correction and processing N-best sentences, is performed (S170). See details described with reference to FIG. 3 for the post-processing task.

Then, the corrected portion is indicated while outputting the final correction sentence having been post-processed together with the sentence to be corrected, so that the corrected sentence according to the embodiment of the present invention with respect to the sentence to be corrected may be provided to the user (S180).

In step S130, when the reliability is less than the preset threshold and the sentence is determined as unnecessary for the language correction, the language modeling processing step (S160) is immediately performed without performing the above-described spelling correction step (S140) and the grammar correction step (S150).

Hereinafter, a method of performing machine learning to generate the correction model that is used above will be described.

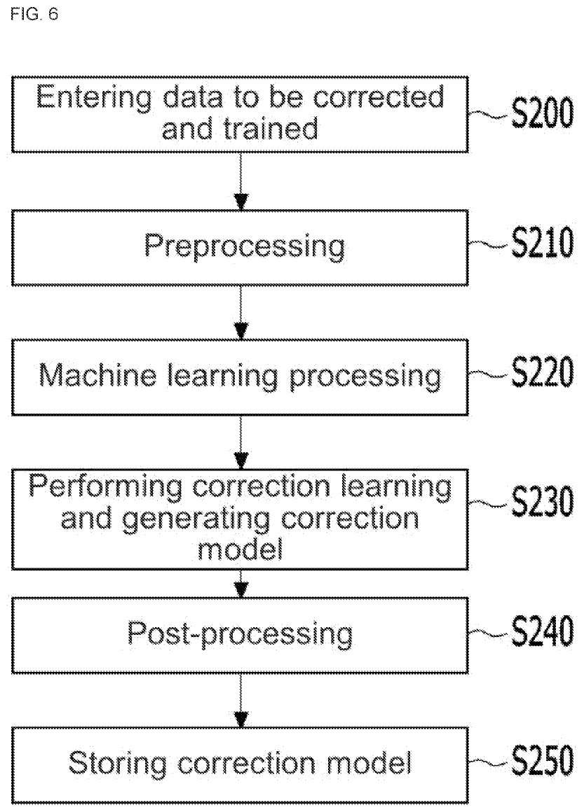

FIG. 6 is a schematic flowchart of a learning a language correction model method according to the embodiments of the present invention. The language correction model learning method shown in FIG. 6 may be performed by the language correction system 100 described with reference to FIGS. 1 to 3.

Referring to FIG. 6, first, when a large amount of training data consisting of data to be corrected and trained for supervised learning-based machine learning for a language correction model, that is, pairs of ungrammatical sentence data and grammatical sentence data, is inputted (S200), a pre-processing task, such as language detection task, data purification task, and normalization task, is performed (S210). See details for the pre-processing task described with reference to FIG. 2.

Next, a machine learning processing task is performed on the data to be corrected and trained in which the pre-processing task has been completed with data necessary for machine learning (S220). The machine learning processing task includes a supervised learning data labeling task, a machine learning data augmentation task, a parallel data construction task for machine learning, and the like. See details described with reference to FIG. 2.

Then, supervised learning-based machine learning is performed by using the data to be corrected and trained in which machine learning processing task has been completed, and then a corresponding correction model is generated (S230). An error occurrence probability value for the machine learning result may be provided together with the correction model.

Next, after errors and error category information are outputted through the tag additional information added by the supervised learning data labeling task during the machine learning processing, a post-processing task of removing the corresponding tag additional information is performed (S240).

Finally, the correction model generated in step S230 is stored in the correction model storage unit 130, so as to be used for language correction of the sentence to be corrected later (S250).

Meanwhile, upon the above-described supervised learning-based correction model learning, the pre-processing part 121 has been described as performing the pre-processing task, such as language detection task, the data purification task, and the normalization task, however, the present invention is not limited thereto. Various types of pre-processing tasks may be additionally performed to perform more accurate machine learning-based correction model learning.

For example, errors (missing and omissions) in the source sentences, which are the ungrammatical sentences used in the correction model learning, are collectively corrected in advance before the correction model learning, so that more accurate source sentences may be used during a practical correction model learning. In particular, pre-correction for words, which are not registered in advance in the source sentences and cannot be identified, may be performed.

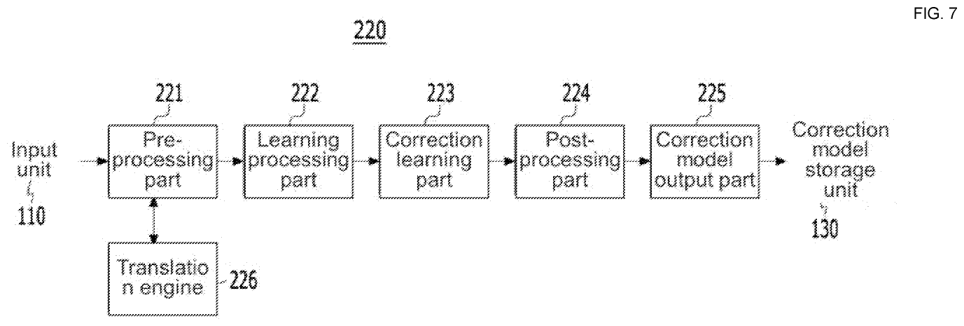

FIG. 7 is a detailed configuration diagram of a correction model learning unit 220 according to another embodiment of the present invention.

As shown in FIG. 7, the correction model learning unit 220 according to another embodiment of the present invention includes a pre-processing part 221, a learning processing part 222, a correction learning part 223, a post-processing part 224, a correction model output part 225, and a translation engine 226. Since the learning processing part 222, the correction learning part 223, the post-processing part 224, and the correction model output part 225 have configurations and functions the same as those of the learning processing part 122, the correction learning part 123, the post-processing part 124, and the correction model output part 125 of the correction model learning unit 120 described with reference to FIG. 2, see the description with reference to FIG. 2.

In FIG. 7, the translation engine 226 refers to an engine that translates an input sentence into a language designated by the user, and may be, for example, a rule based machine translation (RBMT) engine. The present invention is not limited thereto. The rule based machine translation (RBMT) is a scheme of performing a translation based on numerous language rules and language dictionaries. When explained easily, the RBMT may denote a translator in which a linguist entered all textbooks in which English words and grammar are integrated.

The pre-processing part 221 performs translation through the translation engine 226 with respect to a large amount of source data serving as the ungrammatical sentence data in a large amount of data used for learning of language correction inputted through the input unit 110. In addition, when a word is not registered in the dictionary used in the translation engine 226 during performing the translation, a specific marker, such as “##”, is indicated on the word, and then the words marked with the specific marker are extracted and corrected collectively into accurate words when the translation is complete. Herein, the language to be trained in the correction model and the language to perform translation use the same language as the language to be corrected as a starting language. The word units recognized in the pre-processing process for the starting word of the translation engine 226 may indicate unregistered words through a dictionary function and a token separation module, so that unregistered words having a high error rate may be corrected.

Selectively, the pre-processing part 221 extracts words marked with a specific marker, checks a frequency, sorts the words according to the frequency, corrects the sorted words into accurate words, and collectively applies the words, so that the translation engine-based pre-correction may be performed on the large amount of source data.

Accordingly, before the correction model learning, the pre-correction is performed on the large amount of source data to be used for correction learning, so as to allow more accurate source data to be used in actual correction model learning, so that more accurate correction model learning may be performed and accordingly, the efficiency of language correction can improved.

Hereinafter, the pre-correction method of a correction model learning sentence according to another embodiment of the present invention.

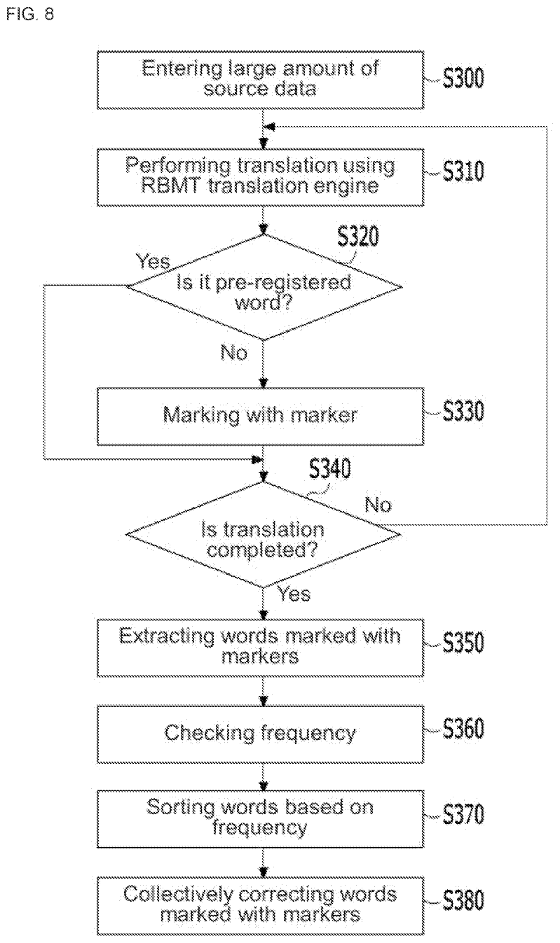

FIG. 8 is a flowchart of a pre-correction method of a correction model learning sentence according to another embodiment of the present invention.

Referring to FIG. 8, first, when a large amount of source data serving as the ungrammatical sentence data in large-capacity data used for language correction learning is inputted through the input unit 110 (S300), translation is performed using the RBMT engine for a large amount of source sentences in the large amount of source data (S310).

During translation, it is determined whether the word is a word registered in the dictionary (S320). When the word is not registered in the dictionary, a marker such as “##” is indicated in front of the corresponding word as the unregistered word (S330).

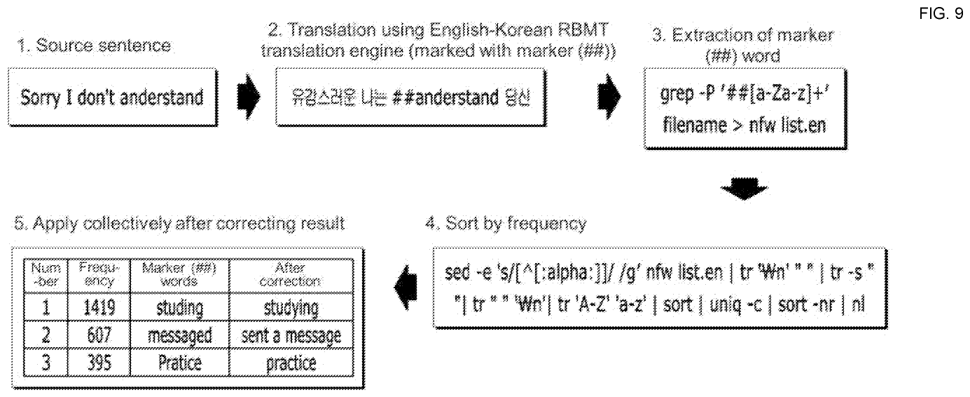

Referring to the example shown in FIG. 9, it can be seen that the source sentence “Sorry I don't anderstand.” is inputted to train the correction model of English sentences (1), and “anderstand” is determined as an unregistered word in the dictionary while the RBMT translation into Korean is being performed on the source sentences and thus the marker “ [symbol] ” is indicated in front of the unregistered word “anderstand” (2).

Accordingly, when the RBMT translation is performed on the large amount of source sentences, markers are indicated on the words that are not registered in the dictionary, and the translation is completed (S340), the words marked with the markers are extracted (S350), the frequency of the extracted words are checked (S360), and then the words are sorted based on the checked frequency (S370). Referring to the example shown in FIG. 9, the words marked with the marker “ [symbol] ” are extracted (3), and the extracted words are checked with the frequency and sorted based on the frequency (4). For example, the words may be sorted based on the frequency in descending order.

Then, accurate words may be used for the sorted words based on the frequency, and correction is performed collectively for the large number of source sentences (S380), so that the words, which are not registered in advance in a large number of source sentences to be used for the correction model learning, may be pre-corrected into accurate words.

Referring back to the example shown in FIG. 9, “Studing”, “messaged”, and “Pratice” are sorted in the order of the word having the highest frequency, and collective correction may be performed for these words with accurate words such as “studying”, “sent a message”, and “practice” (5).

Meanwhile, in the case, like proper nouns, applied differently from the meaning of the original text, or having the first letter required to be used in an uppercase letter during translation or correction, a user dictionary may be used to store correction information in a predefined form to have a variable form so that the correction information is processed at runtime.

Hereinafter, a method, which creates the user dictionary to register values (words) required by the user, and produces results with set values, will be described.

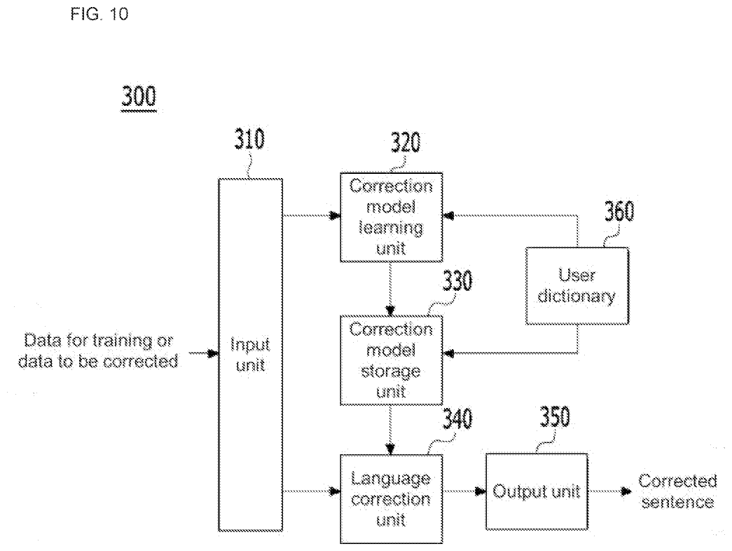

FIG. 10 is a schematic configuration diagram of a language correction system 300 according to another embodiment of the present invention.

As shown in FIG. 10, the language correction system 300 according to another embodiment of the present invention includes an input unit 310, a correction model learning unit 320, a correction model storage unit 330, a language correction unit 340, an output unit 350, and a user dictionary 360. Since the input unit 310, the correction model storage unit 330, and the output unit 350 are the same as the input unit 110, the correction model storage unit 130, and the output unit 150 described with reference to FIG. 1, the description thereof will be omitted, and only the correction model learning unit 320, the language correction unit 340, and the user dictionary 360 having different configurations will be described.

First, the user dictionary 360 stores values (words) previously defined by the user for specific words. For example, the user may create and use the user dictionary for word(s), such as proper nouns, “Labor day”-“Labor DAY”, “memorial day”-“Memorial Day”, “african amerian history month”-“African Amerian History Month”, that may not be properly corrected as intention due to the meaning different from the original meaning during language correction. Hereinafter, “word” is assumed to mean “word” or “words” for convenience of explanation.

Accordingly, in another embodiment of the present invention, it is assumed that the user dictionary 360 has been previously generated by the user for some words.

The correction model learning unit 320 performs machine learning for language correction by using data used for learning of language correction among the data inputted through the input unit 310, that is, a large amount of learning data consisting of a pair of ungrammatical sentence data and grammatical sentence data, so that a correction model serving as a learning model for language correction is generated.

In particular, the correction model learning unit 320 according to another embodiment of the present invention searches for words registered in the user dictionary 360 from the large amount of training data consisting of pairs of the ungrammatical sentence data and the grammatical sentence data, replaces the words with a user dictionary marker such as “UD_NOUN”, and then performs machine learning to generate the correction model.

Various types of special symbols, such as “<<”, “>>”, and “_”, may be further added to the user dictionary marker “UD_NOUN” so as to be recognized as the user dictionary marker before and after the user dictionary marker. A position of the user dictionary marker is trained through the machine learning, so that specifically, contextual information may be learned. When several different words included in one learning data, that is, in one sentence are registered in the user dictionary 360, distinguishable user dictionary markers may be used and replaced, so that machine learning may be performed to have different positions of the user dictionary markers. For example, when three different words are contained in one sentence, and the words are registered in the user dictionary 360, the words may be replaced using “UD_NOUN #1”, “UD_NOUN #2”, and “UD_NOUN #3”, respectively.

Next, the language correction unit 340 performs spelling/grammar correction on the data to be corrected using the correction model stored in the correction model storage unit 330 with respect to the large amount of language correction data inputted through the input unit 310, that is, the data to be corrected as a correction object for spelling errors or grammar errors, and outputs correction data having completed in correction to the output unit 350.

In particular, when words registered in the user dictionary are present in the data to be corrected, the language correction unit 340 according to another embodiment of the present invention replaces the words with user dictionary markers and then uses the correction model to perform spelling/grammar correction. In addition, the words corresponding to the user dictionary marker included in the subsequent result are replaced with the result values (words) registered in the user dictionary, so that the language correction may be completed. When several different words included in one data to be corrected, that is, in one sentence are registered in the user dictionary 360, distinguishable user dictionary markers may be used and replaced, and the spelling/grammar correction is performed. Thereafter, words corresponding to different user dictionary markers are found from the user dictionary 360 and replaced, so that the correction may be completed. For example, when three different words are included in one sentence to be corrected, and the words are registered in the user dictionary 360, the words may be replaced using “UD_NOUN #1”, “UD_NOUN #2”, and “UD_NOUN #3”, respectively, and then the correction is performed. After the correction is completed, the words corresponding to “UD_NOUN #1”, “UD_NOUN #2”, and “UD_NOUN #3” are replaced with the words registered in the user dictionary 360, so that the correction may be completed.

The correction model learning unit 320 and the language correction unit 340 according to another embodiment of the present invention as described above will be described in more detail.

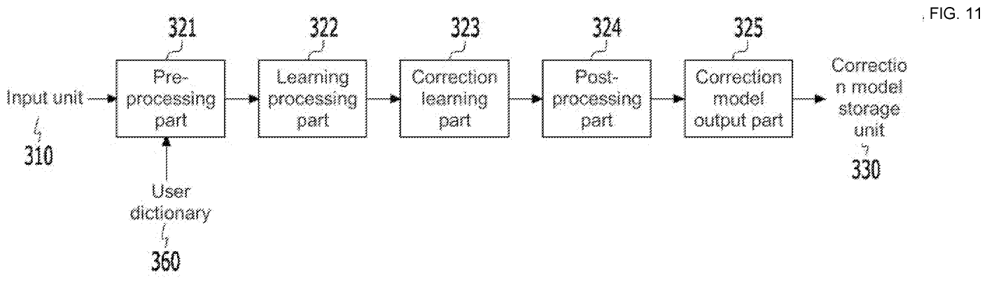

FIG. 11 is a detailed configuration diagram of the correction model learning unit 320 shown in FIG. 10.

As shown in FIG. 11, the correction model learning unit 320 includes a pre-processing part 321, a learning processing part 322, a correction learning part 323, a post-processing part 324, and a correction model output part 325. Since the learning processing part 322, the correction learning part 323, the post-processing part 324, and the correction model output part 325 are the same as the learning processing part 122, the correction learning part 123, the post-processing part 124, and the correction model output part 125 described with reference to FIG. 2, detailed descriptions will be omitted herein, and only the pre-processing part 321 having different configurations will be described.

The pre-processing part 321 performs the functions of the pre-processing part 121 described with reference to FIG. 2. Further, when data used for language correction learning, that is, learning data consisting of a pair of the ungrammatical sentence data (denoting source sentences) and the grammatical sentence data (denoting target sentences) is inputted through the input unit 110, the pre-processing part 321 checks whether the words registered in the user dictionary 360 are included in the learning data. When included, the include words are replaced with user dictionary markers such as “<<UD_NOUN>>”.

Accordingly, the machine learning is performed through the pre-processing part 321, the learning processing part 322, the correction learning part 323, the post-processing part 324, and the correction model output part 325 and replaced with “<<UD_NOUN>>”, so that positions of the user dictionary marker may be trained.

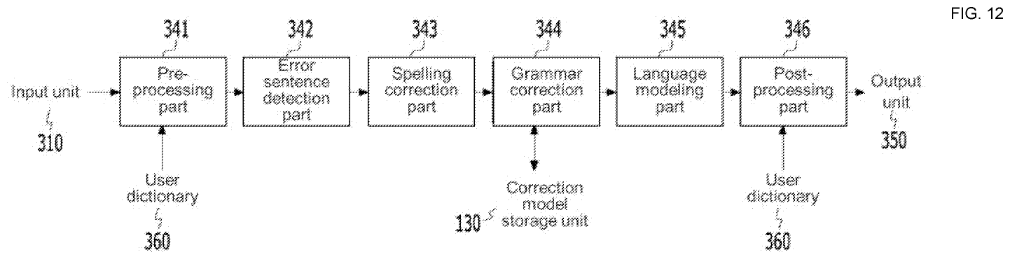

FIG. 12 is a detailed configuration diagram of the language correction unit 340 shown in FIG. 10.

As shown in FIG. 12, the language correction unit 340 includes a pre-processing part 341, an error sentence detection part 342, a spelling correction part 343, a grammar execution part 344, a language modeling part 345, and post-processing part 346. Since the error sentence detection part 342, the spelling correction part 343, the grammar correction part 344, and the language modeling part 346 are the same as the error sentence detection part 142, the spelling correction part 143, the grammar correction part 144, and the language modeling part 145 described with reference to FIG. 3, detailed descriptions will be omitted herein, and only the pre-processing part 341 and the post-processing part 346 having different configurations will be described.

The pre-processing part 341 checks whether the words registered in the user dictionary 360 are included in the data to be corrected for language correction inputted through the input unit 310. When included, the include words are replaced with user dictionary markers such as “<<UD_NOUN>>”.

When the user dictionary marker, such as, “<<UD_NOUN>>” is included in the corrected data in which the language modeling has been performed by the language modeling unit 345, the post-processing part 346 replaces the source sentences corresponding to the user dictionary marker, that is, the words in the ungrammatical sentence data with values (words) registered in the user dictionary 360.

Accordingly, the words previously registered in the user dictionary 360 are replaced with the user dictionary marker in advance in the pre-processing part 341, so that the user pre-marker may be inputted to the post-processing part 346 without any correction when correcting language, that is, when correcting spelling and grammar using a correction model in which contextual information about user dictionary markers is learned. Thus, the user dictionary 360 can be used to replace the corresponding words in the post-processing part 346.

Accordingly, the correction based on the user dictionary 360 may be successfully performed on the source sentences including the words registered in the user dictionary 360.

Hereinafter, a language correction model learning method according to another embodiment of the present invention will be described with reference to the drawings. The language correction model learning method may be performed by the language correction system 300 described with reference to FIGS. 10 to 12.

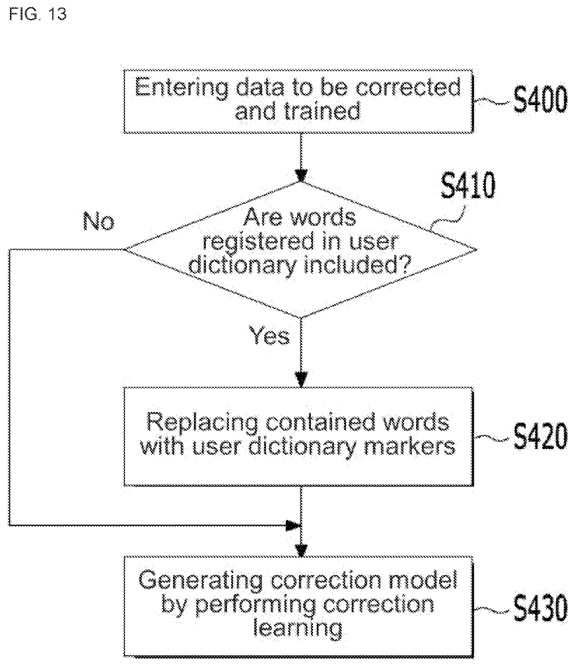

FIG. 13 is a flowchart of the language correction model learning method according to another embodiment of the present invention. The language correction model learning method according to another embodiment of the present invention shown in FIG. 13 may be performed by the language correction system 300 described with reference to FIGS. 10 to 12 according to another embodiment of the present invention.

Before the description, it is assumed that the user dictionary 360 that stores values (words) predefined by the user for specific words has been configured in advance.

Referring to FIG. 13, first, when data used for language correction learning, that is, learning data consisting of a pair of the ungrammatical sentence data (denoting source sentences) and the grammatical sentence data (denoting target sentences) is inputted (S400), it is determined whether the word registered in the user dictionary 360 is included in the source sentences and the target sentences (S410).

When the words registered in the user dictionary 360 are determined as being included in the source sentences and the target sentences, a word matching the word registered in the user dictionary 360 is replaced with a user dictionary marker (S420). For example, when <“memorial day”-“Memorial Day”> is registered in the user dictionary 360, and when the source sentence inputted for language correction learning is “memorial day is observed on the last Monday”, the word “memorial day” in the source sentence is registered in the user dictionary 360, so this word is replaced with the user dictionary marker, such as “<<UD_NOUN>>”, and thus the source sentence is changed as “<<UD_NOUN>> is observed on the last Monday”.

However, when the word registered in the user dictionary 360 is not included in the source sentence and the target sentence, the source sentence and the target sentence may be used as inputted without being changed.

Then, a correction model is generated by performing machine learning with respect to language correction learning data that is the changed or unchanged source and target sentences (S430). The position of the user dictionary marker may be learned through the machine learning. In addition, for details of performing machine learning, refer to the embodiments described with reference to FIGS. 1 to 9.

Next, a language correction method according to another embodiment of the present invention will be described. The language correction method may be performed by the language correction system 300 described with reference to FIGS. 10 to 12.

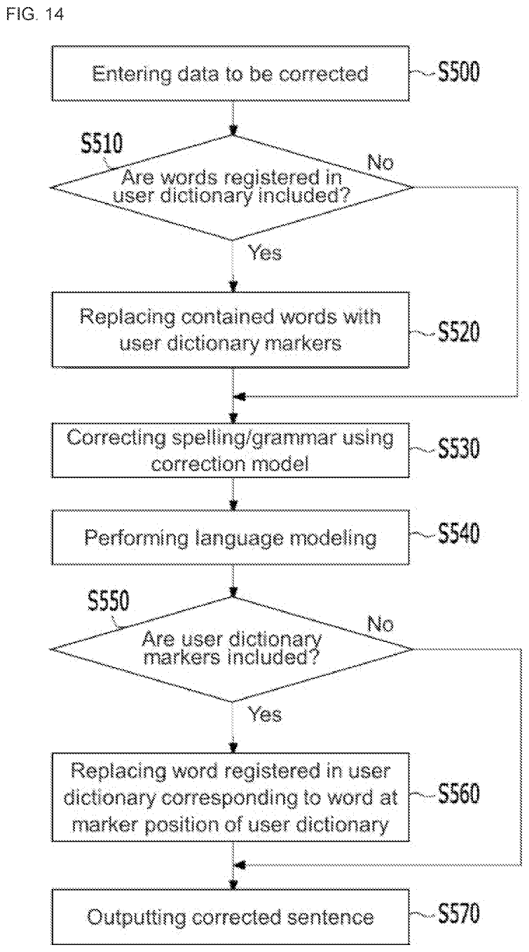

FIG. 14 is a flowchart of the language correction method according to another embodiment of the present invention. The language correction model learning method shown in FIG. 14 according to another embodiment of the present invention may be performed by the language correction system 300 described with reference to FIGS. 10 to 12 according to another embodiment of the present invention.

Before the description, it is assumed that the user dictionary 360 that stores values (words) predefined by the user for specific words has been configured in advance.

When the language correction data, that is, the data to be corrected as a correction target of a spelling error or grammar error is inputted (S500) it is checked whether the word registered in the user dictionary 360 is included in the data to be corrected (S510).

When the word registered in the user dictionary 360 is confirmed as being included in the data to be corrected, the corresponding word is replaced with the user dictionary marker such as “<<UD_NOUN>>” (S520). Referring to the above-described example shown in FIG. 13, when <“memorial day”-“Memorial Day”> is registered in the user dictionary 360, and when the sentence to be corrected “memorial day is observed on the last Monday” is inputted, the “memorial day” in the sentence is a word registered in the user dictionary (360), so this corresponding word is replaced with the user dictionary marker, that is, “<<UD_NOUN>>”, and as a result, the sentence to be corrected is “<<UD_NOUN>> is observed on the last Monday”.

Then, the spelling/grammar correction is performed on the data to be corrected by using the correction model generated through language correction learning as described with reference to FIGS. 10 to 13 (S530), and language modeling is performed on the corrected result (S540).

Then, it is checked that the user dictionary marker, that is, “<<UD_NOUN>>” is present in the sentence of the language modeling result (S550). When the user dictionary marker is present, the word of the source sentence corresponding to the user dictionary marker is replaced with the word registered in the user dictionary 360 (S560). Referring to the above example, since the user dictionary marker “<<UD_NOUN>>” is included in the sentence “<<UD_NOUN>> is observed on the last Monday” that is outputted as a result of the language modeling, the word corresponding to the user dictionary marker “<<UD_NOUN>>”, that is, “memorial day” is replaced with the word registered in the user dictionary 360, that is, “Memorial Day”, so that “Memorial Day is observed on the last Monday”, which is the sentence after the correction, is finally completed.

Then, the correction sentence completed in correction is outputted (S570).

Meanwhile, when the user dictionary marker is not included in the sentence outputted as a result of the language modeling in step S550, a step (S570) of immediately outputting the corrected sentence is performed.

According to the embodiments of the present invention, correction information in the form predefined by the user may be stored in the form of a variable and processed in the runtime, so that the language correction can be easily performed without a separate addition or change to the correction model.

Accordingly, even portions that are difficult to correct or cannot be treated smoothly may be registered in the user dictionary and processed, so that the efficiency of language correction can be improved.

The embodiments of the present invention described above are not implemented only through an apparatus and a method, and may be implemented through a program for realizing a function corresponding to the configuration of the embodiment of the present invention or a recording medium on which the program is recorded.

Although the embodiments of the present invention have been described in detail above, the scope of the present invention is not limited thereto. Various modifications and improvements of those skilled in the art using the basic concept of the present invention defined in the following claims also belong to the scope of the present invention.

1. A machine learning-based language correction system comprising:
a correction model learning unit that performs machine learning on a plurality of data sets including ungrammatical sentence data and error-free grammatical sentence data respectively corresponding to the ungrammatical sentence data to generate a correction mode for detecting grammatical sentence data corresponding to ungrammatical sentence data to be corrected; and
a language correction unit that generates, for a sentence to be corrected, a corresponding corrected sentence by using the correction model generated by the correction model learning unit, and indicates and outputs the corrected parts together with the generated corrected sentence.

2. The language correction system of claim 1, wherein the correction model learning unit includes:
a pre-processing part that performs a filtering task into a monolingual sentence and a data purification and normalization task by performing language detection on the ungrammatical sentence data;
a learning processing part that performs a supervised learning data labeling task, a machine learning data expansion task, and a parallel data construction task for machine learning, with respect to a plurality of data sets filtered by the pre-processing part;
a correction learning part that generates the corresponding correction model by performing supervised learning-based machine learning on the data sets processed by the learning processing part; and
a first post-processing part that outputs errors and error category information through tag additional information added during the supervised learning data labeling task in the learning processing part and then removes the corresponding tag additional information.

3. The machine learning-based language correction system of claim 2, wherein the machine learning data expansion task in the learning processing part includes a data expansion task using letters formed from surrounding typing error characters around an in-position of a keyboard for typing letters included in the ungrammatical sentence data.

4. The machine learning-based language correction system of claim 2, wherein the parallel data construction task for machine learning in the learning processing part includes a task of constructing parallel data using a parallel corpus formed by paring ungrammatical sentences unnecessary for correction and corresponding grammatical sentences.

5. The machine learning-based language correction system of claim 2, wherein the correction learning part provides an error occurrence probability value, for a learning result in the supervised learning-based machine learning, as attention weight information between the ungrammatical sentence data and the grammatical sentence data.

6. The machine learning-based language correction system of claim 2, further comprising:
a translation engine for translating input sentences into a preset language, wherein
the pre-processing part marks words, which are unregistered in a dictionary used by the translation engine, by using a preset marker while performing a translation on a large amount of ungrammatical sentence data in the data sets through the translation engine, completes the translation on the large amount of ungrammatical sentence data, and then performs preliminary correction of extracting the words marked by the preset marker to collectively correct the words into error-free words.

7. The machine learning-based language correction system of claim 6, wherein the pre-processing part checks a frequency while extracting the words marked by the preset marker, and aligns the words marked by the preset marker based on the checked frequency to collectively correct the words into error-free words.

8. The machine learning-based language correction system of claim 1,
wherein the language correction unit includes:
a pre-processing part that performs pre-process of performing a sentence segmentation, for sentences to be corrected, in a unit of sentence, and tokenizing the segmented sentences;
an error sentence detection part for classifying an error sentence and a non-error sentence by using a binary classifier on the sentence to be corrected that has been pre-processed by the pre-processing part;
a spelling correction part for correcting a spelling error on the sentence to be corrected when the sentence to be corrected is classified as the error sentence by the error sentence detection part;
a grammar correction part for generating a corrected sentence by performing language correction for grammar correction using the correction model on the sentence in which the spelling error is corrected by the spelling correction part; and
a post-processing part that performs post-processing of indicating a corrected portion during the language correction by the grammar correction part and outputs the corrected portion together with the corrected sentence.

9. The machine learning-based language correction system of claim 8, wherein the error sentence detection part classifies the sentence to be corrected into the error sentence and the non-error sentence according to reliability information recognized when the sentence to be corrected is classified.

10. The machine learning-based language correction system of claim 8, wherein the spelling correction part provides a spelling error occurrence probability value as reliability information when correcting a spelling error, the grammar correction part provides a probability value through an attention weight of language correction for the spelling error-corrected sentence as reliability information, and the post-processing part provides final reliability information of language correction for the sentence to be corrected by combining the reliability information provided by the spelling correction part and the reliability information provided by the grammar correction part.

11. The machine learning-based language correction system of claim 10, further comprising:
a language modeling unit that performs language modeling using a preset recommended sentence for the corrected sentence generated by the grammar correction part, between the grammar correction part and the post-processing part, wherein
the language modeling unit provides reliability information of the corrected sentence by combining a perplexity value and a mutual information (MI) value of a language model during the language modeling, and the post-processing part also combines the reliability information provided by the language modeling unit when providing the final reliability information.

12. The machine learning-based language correction system of claim 1, further comprising:
a user dictionary including a source word registered by a user and a target word corresponding thereto, in which each of the source word and the target word is at least one word, wherein
the correction model learning part, when the word registered in the user dictionary is included in the data sets, replaces the word registered in the user dictionary and included in the data sets with a preset user dictionary marker to perform machine learning, and
the language correction unit, when the word included in the user dictionary is present in the sentence to be corrected, replaces the word included in the user dictionary and present in the sentence to be corrected with the user dictionary marker to perform language correction on the sentence to be corrected, and when the user dictionary marker is included in the corrected sentence, replaces the user dictionary marker included in the corrected sentence with the word registered in the user dictionary to correspond to a corresponding word in the sentence to be corrected.

13. A method for enabling a language correction system to learn a language correction model based on machine learning, the method comprising:
performing a learning processing including a supervised learning data labeling task, a machine learning data expansion task, and a parallel data construction task for machine learning on a plurality of data sets including ungrammatical sentence data and error-free grammatical sentence data corresponding to the ungrammatical sentence data, respectively; and
generating a corresponding correction model by performing supervised learning-based machine learning on the data sets on which the learning processing has been performed.

14. The method of claim 13, wherein
the machine learning data expansion task includes a data expansion task using letters formed from surrounding typing error characters around an in-position of a keyboard for typing letters included in the ungrammatical sentence data, and
the parallel data construction task for machine learning includes a task of constructing parallel data using a parallel corpus formed by paring ungrammatical sentences unnecessary for correction and corresponding grammatical sentences.

15. The method of claim 13, further comprising:
performing pre-processing including a filtering task into a monolingual sentence and a data purification and normalization task by performing language detection on the data sets before performing the learning processing, wherein
the performing of the pre-processing includes:
performing a translation on a large amount of ungrammatical sentence data in the data sets through the translation engine;
marking words, which are unregistered in a dictionary used by the translation engine, by using a preset marker, completing the translation on the large amount of ungrammatical sentence data, and then extracting the words marked by the preset marker; and
collectively correcting the extracted words into error-free words.

16. The method of claim 15, wherein the collectively correcting of the words includes:
extracting the words marked by the preset marker;
checking a frequency of the extracted words;
arranging the words marked by the preset marker based on the checked frequency; and
collectively correcting the arranged words into error-free words.

17. The method of claim 13, wherein the language correction system further includes a user dictionary including a source word registered by a user and a target word corresponding thereto, in which each of the source word and the target word is at least one word, and
the generating of the correction model includes replacing, when the word registered in the user dictionary is included in the data sets, the word registered in the user dictionary and included in the data sets with a preset user dictionary marker to perform machine learning, thereby generating the correction model.

18. A method for enabling a language correction system to perform a language correction based on machine learning, the method comprising: performing spelling error correction on sentences to be corrected; and generating a corrected sentence by performing grammar correction by using a correction model on the spelling error-corrected sentence, wherein the correction model is generated by performing supervised learning-based machine learning on
a plurality of data sets consisting of ungrammatical sentence data and error-free grammatical sentence data corresponding to the ungrammatical sentence data, respectively.

19. The method of claim 18, further comprising: before the performing the spelling error correction,
performing a sentence segmentation, for the sentences to be corrected, in a unit of sentence and performing pre-process of tokenizing the segmented sentences; and
classifying the sentences to be corrected that has been pre-processed into error sentences and non-error sentences by using a binary classifier, wherein
the classifying of the error sentences and the non-error sentences includes performing the spelling error correction when the sentence to be corrected is classified as the error sentence.

20. The method of claim 19, wherein the classifying of the error sentences and the non-error sentences further includes classifying the error sentence and the non-error sentence according to reliability information recognized when the sentence to be corrected is classified.

21. The method of claim 18, further comprising: after the generating of the corrected sentence,
performing language modeling on the corrected sentence by using a preset recommendation sentence; and
performing post-processing of indicating a corrected portion during the generating of the corrected sentence to output the corrected portion together with the corrected sentence.

22. The method of claim 18, wherein the language correction system includes a user dictionary including a source word registered by a user and a target word corresponding thereto, in which each of the source word and the target word is at least one word, and wherein
the method further comprises: before the performing the spelling error correction,
determining whether the word included in the user dictionary is included in the sentence to be corrected; and
replacing a word commonly included in the user dictionary and the sentence to be corrected with a preset user dictionary marker when the word included in the user dictionary is included in the sentence to be corrected, and
the method further comprises: after the generating of the corrected sentence,
checking whether the user dictionary marker is included in the generated corrected sentence; and
generating a final corrected sentence, when the user dictionary marker is included in the generated corrected sentence, by replacing the word in the user dictionary corresponding to the word in the sentence to be corrected corresponding to a position of the included user dictionary marker.
